(19) United States
(12) Patent Application Publication
(10) Pub. No.: US 2013/0058679 A1
(43) Pub. Date: Mar. 7, 2013

(54) CHARGER AND IMAGE FORMING APPARATUS

(71) Applicants: Hidekazu SHONO, Hyogo (JP); Manabu HAMADA, Osaka (JP)

(72) Inventors: Hidekazu SHONO, Hyogo (JP); Manabu HAMADA, Osaka (JP)

(73) Assignee: RICOH COMPANY, LTD., Tokyo (JP)

(21) Appl. No.: 13/601,438

(22) Filed: Aug. 31, 2012

(30) Foreign Application Priority Data
Sep. 5, 2011 (JP) 2011-192697

(51) Int. Cl. G03G 15/02

(52) U.S. Cl. 399/100

(57) ABSTRACT

A charger adapted to uniformly charge a surface of an image bearing member is provided. The charger includes a charging roller, a charging roller cleaning member, and a cleaning member moving device. The charging roller is in contact with a surface of the image bearing member and is rotatable. The charging roller cleaning member is in uniform contact with the charging roller in a longitudinal direction. The cleaning member moving device is adapted to reciprocate the charging roller cleaning member in a direction orthogonal to the longitudinal direction of the charging roller while keeping the charging roller cleaning member in contact with the charging roller.

### CROSS-REFERENCE TO RELATED APPLICATIONS

This patent application is based on and claims priority pursuant to 35 U.S.C. §119 to Japanese Patent Application No. 2011-192697, filed on Sep. 5, 2011, in the Japanese Patent Office, the entire disclosure of which is hereby incorporated herein by reference.

### BACKGROUND

1. Technical Field

The present disclosure relates to a charger having a charging roller cleaning member and an image forming apparatus having the charger.

2. Description of Related Art

In the field of electrophotography, a rotatable elastic roller having a conductive layer is widely used as a charging roller for charging photoreceptor. The charging roller uniformly charges a surface of a photoreceptor by being supplied with a voltage and causing electric discharge.

In an electrophotographic image forming apparatus, such as copier, facsimile machine, and printer, a surface of a photoreceptor, serving as an electrostatic latent image bearing member, is uniformly charged when a charger (e.g., the charging roller) causes electric discharge. The charged surface of the photoreceptor is irradiated with laser light so that an electrostatic latent image is formed thereon. The electrostatic latent image is developed into a toner image that is visible with toner particles supplied from a developing device. The toner image is transferred from the photoreceptor onto a recording medium, such as paper, by a transfer device. The toner image is finally fixed on the recording medium by a fixing device and the recording medium having the fixed toner image is output as a copy or print. Residual toner particles remaining on the photoreceptor without being transferred onto the recording medium are removed and collected by a cleaner downstream from the transfer device. Thus, the photoreceptor gets ready for a next image forming operation.

As a method of charging photoreceptor, a contact charging method is known. In the contact charging method, a charging roller comprised of a metallic core shaft covered with a conductive elastic layer is generally employed. The charging roller is brought into continuous contact with a photoreceptor and is rotated as the photoreceptor rotates. Upon application of a voltage to the core shaft, electric discharge is caused on the surface of the photoreceptor and the photoreceptor is charged.

It is known that the contact charging method can keep the discharge starting voltage lower than a scorotron charging method that causes wire discharge. Therefore, the contact charging method can advantageously reduce the amount of ozone generation during energy-saving or discharging operations.

Because the elastic charging roller is in continuous contact with the photoreceptor, it is likely that foreign substances adhered to the photoreceptor may be undesirably transferred onto the charging roller. In a case in which residual toner particles are not completely removed from the photoreceptor, the charging roller may be contaminated with the remaining residual toner particles and additives releases therefrom. The contaminated charging roller cannot uniformly charge the photoreceptor and therefore the resulting image may have uneven image density or undesirable linear defective portions.

In attempting to solve this problem, charging roller cleaning members have been proposed. For example, as illustrated in FIG. 1, a charging roller cleaning member 22 in a form of brush roller has been proposed. The brush roller as the charging roller cleaning member 22 is rotated while contacting a charging roller 21 so as to remove toner particles and additives undesirably adhered to the charging roller 21. In FIG. 1, a numeral 1 denotes a photoreceptor drum.

However, it may be difficult for compact and low-cost image forming apparatuses to secure a space for the brush roller and its driver. In view of this situation, a charging roller cleaning member 22 in a form of platy brush, as illustrated in FIG. 2, and that in a form of non-woven fabric have been proposed particularly for compact and low-cost image forming apparatuses. Referring to FIG. 2, the platy brush as the charging roller cleaning member 22 is brought into contact with the charging roller 21 so as to remove toner particles and additives undesirably adhered to the charging roller 21.

In this case, only particular part of the charging roller cleaning member 22 is in continuous contact with a surface of the charging roller 21. Therefore, the charging roller cleaning member 22 significantly reduces its cleaning performance once the particular part has removed a certain amount of fouling.

Japanese Patent Application Publication No. 08-123140 discloses a charger having a charging roller and a charging roller cleaning member. The charging roller cleaning member can be brought into reciprocating motion in a longitudinal direction of the charging roller while contacting the charging roller.

Owing to the reciprocating motion of the charging roller cleaning member, no particular part of the charging roller cleaning member is brought into continuous contact with any particular part of the charging roller. The charging roller is cleaned with a greater part of the charging roller cleaning member. Contaminants are not concentrated on any particular part of the charging roller cleaning member.

However, during the reciprocating motion, the most part, except for the end parts, of the charging roller cleaning member is brought into continuous contact with the charging roller. Once the most part of the charging roller cleaning member gets contaminated, it is difficult to suppress further contamination thereof. As a result, cleaning performance of the charging roller cleaning member may deteriorate and the resulting image may have uneven image density or undesirable lines.

### SUMMARY

In accordance with some embodiments, a charger is provided. The charger is adapted to uniformly charge a surface of an image bearing member. The charger includes a charging roller, a charging roller cleaning member, and a cleaning member moving device. The charging roller is in contact with a surface of the image bearing member and is rotatable. The charging roller cleaning member is in uniform contact with the charging roller in a longitudinal direction. The cleaning member moving device is adapted to reciprocate the charging roller cleaning member in a direction orthogonal to the longitudinal direction of the charging roller while keeping the charging roller cleaning member in contact with the charging roller.

In accordance with some embodiments, an image forming apparatus is provided. The image forming apparatus includes an image bearing member, the above charger, an irradiator, a developing device, a transfer device, and a cleaner. The irradiator is adapted to irradiate the charged surface of the image bearing member to form an electrostatic latent image thereon. The developing device is adapted to develop the electrostatic latent image into a toner image with toner particles. The transfer device is adapted to transfer the toner image from the image bearing member onto a recording medium or an intermediate transfer medium. The cleaner is adapted to remove residual toner particles remaining on the image bearing member without being transferred.

### BRIEF DESCRIPTION OF THE DRAWINGS

A more complete appreciation of the disclosure and many of the attendant advantages thereof will be readily obtained as the same becomes better understood by reference to the following detailed description when considered in connection with the accompanying drawings, wherein:

FIG. 1 is a schematic view of a related-art charging roller cleaning member;

FIG. 2 is a schematic view of another related-art charging roller cleaning member;

FIG. 3 is a schematic view of an image forming apparatus according to an embodiment;

FIG. 4 is a magnified view of the imaging unit in the image forming apparatus illustrated in FIG. 3;

FIG. 5 is a conceptional view of a charging roller cleaning member in accordance with some embodiments;

FIG. 6 is an axial cross-sectional view of a charging roller cleaning member according to an embodiment;

FIG. 7 is a perspective view of a guide mechanism for reciprocating a charging roller cleaning member according to an embodiment;

FIG. 8 is a perspective view of a charging roller cleaning member according to an embodiment;

FIG. 9 is an axial cross-sectional view of a charging roller cleaning member according to another embodiment;

FIG. 10 is an axial cross-sectional view of a charging roller cleaning member according to another embodiment; and

FIG. 11 is a magnified perspective view of a charging roller cleaning member according to an embodiment.

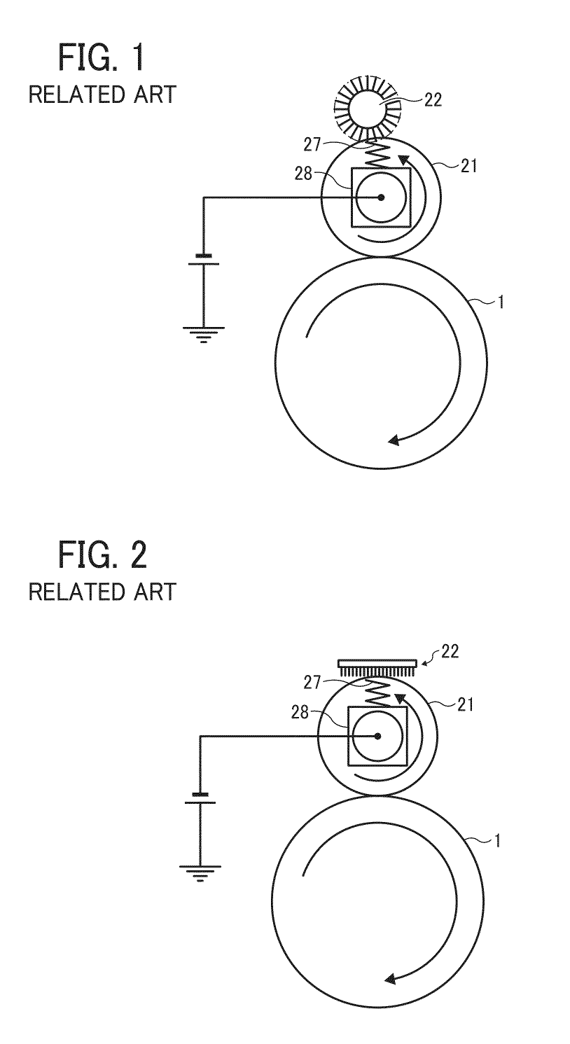

### DETAILED DESCRIPTION

Embodiments of the present invention are described in detail below with reference to accompanying drawings. In describing embodiments illustrated in the drawings, specific terminology is employed for the sake of clarity. However, the disclosure of this patent specification is not intended to be limited to the specific terminology so selected, and it is to be understood that each specific element includes all technical equivalents that operate in a similar manner and achieve a similar result.

For the sake of simplicity, the same reference number will be given to identical constituent elements such as parts and materials having the same functions and redundant descriptions thereof omitted unless otherwise stated.

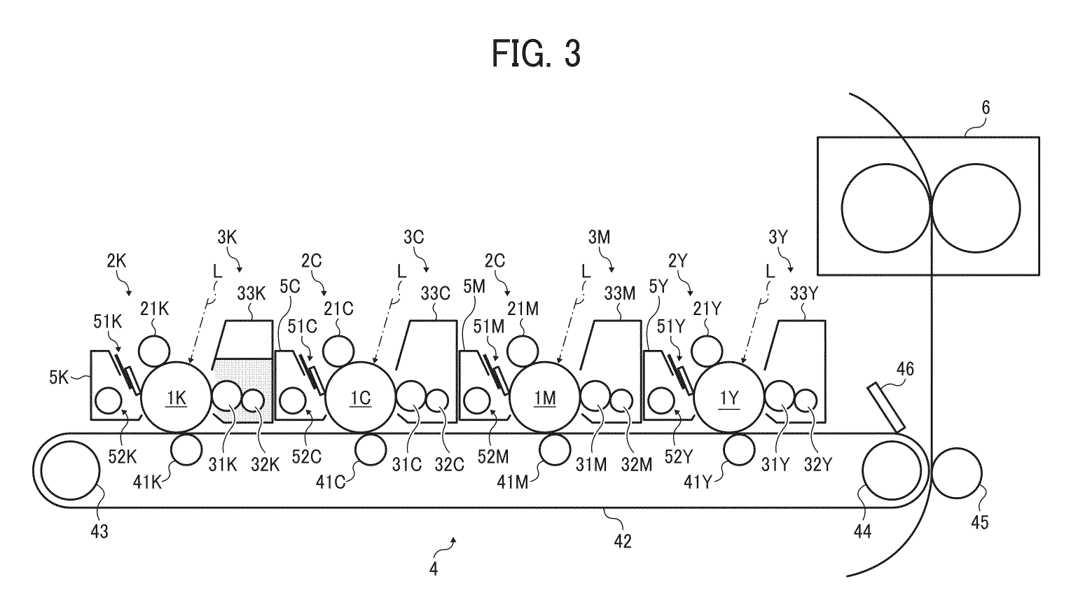

FIG. 3 is a schematic view of an image forming apparatus according to an embodiment. An image forming apparatus illustrated in FIG. 3 includes tandemly-arranged four imaging units of yellow, magenta, cyan, and black. Each imaging unit includes a photoreceptor drum 1. The photoreceptor drum 1 has a surface photosensitive layer comprised of an organic material and is rotatable clockwise in FIG. 3. Around the photoreceptor drum 1, a charger 2, an irradiator that emits laser light L, a developing device 3, and a cleaner 5 are disposed. The additional characters Y, M, C, and K representing colors of yellow, magenta, cyan, and black, respectively, are added or omitted as appropriate.

The charger 2 includes a charging roller 21 having a conductive elastic layer. The charging roller 21 is urged by a spring 27 via a bearing 28 toward the photoreceptor drum 1 and is in contact with a surface of the photoreceptor drum 1. When the charging roller 21 starts rotating, the photoreceptor drum 1 is supplied with a direct current voltage or a superimposed voltage of direct current with alternating current from a high-voltage power source. As a result, the surface photosensitive layer of the photoreceptor drum 1 is uniformly charged.

The photoreceptor drum 1 is then irradiated with the laser light L so that an electrostatic latent image is formed thereon. In the present embodiment, the developing device 3 is a so-called contact one-component developing device including a developing roller 31. The developing roller 31 may be comprised of an elastic body, for example. The developing roller 31 is brought into contact with the surface of the photoreceptor drum 1 so that the electrostatic latent image is developed into a toner image. In the contact one-component developing device, a one-component developer, comprised of toner particles, is contained in a hopper 33. A supply roller 32 supplies the developer onto the developing roller 31. A regulating blade 34 forms a thin layer of the developer on the developing roller 31. The thin layer of the developer formed on the developing roller 31 is brought into contact with the electrostatic latent image formed on the photoreceptor drum 1 so that the electrostatic latent image is developed into a toner image.

A transfer device 4 includes driving rollers 43 and 44; a transfer belt 42 stretched between the driving rollers 43 and 44; primary transfer rollers 41Y, 41M, 41C, and 41K contactable with the respective photoreceptor drums 1Y, 1M, 1C, and 1K with the transfer belt 42 therebetween; a secondary transfer roller 45 in contact with the transfer belt 42; and a transfer cleaner 46 that removes and collects residual toner particles remaining on the transfer belt 42 downstream from the secondary transfer roller 45.

Each toner image formed in each imaging unit is sequentially transferred from each photoreceptor drum 1 onto the transfer belt 42 upon application of a bias voltage to each primary transfer roller 41 from a high-voltage power source. As a result, a composite full-color toner image is formed on the transfer belt 42. The composite full-color toner image is transferred onto a sheet of transfer paper (hereinafter simply “transfer paper”) at a position where the secondary transfer roller 45 faces the driving roller 44 upon application of a bias voltage to the secondary transfer roller 45 from a high-voltage power source. The transfer paper is fed to that position in synchronization with an entry of the composite full-color toner image into that position.

The transfer paper having the composite full-color toner image thereon is then conveyed to a fixing device 6. In the fixing device 6, the composite full-color toner image is fixed on the transfer paper upon application of heat and pressure. The transfer paper having the fixed toner image is ejected onto an ejection tray.

Residual toner particles remaining on the photoreceptor drum 1 without being transferred onto the transfer belt 42 are collected by the cleaner 5 downstream from the photoreceptor drum 1 relative to the direction of rotation of the photoreceptor drum 1.

The cleaner 5 includes a blade 51 comprised of an elastic body comprised of an urethane base material. The blade 51 is in contact with the photoreceptor drum 1 at predetermined angle and pressure. The blade 51 scrapes off most of the residual toner particles from the surface of the photoreceptor drum 1. Thus, the surface of the photoreceptor drum 1 is kept cleaned to be ready for a next imaging operation. Toner particles scraped off by the blade 51 are conveyed to a collecting part by a conveying screw 52 provided within the cleaner 5. A surface of the photoreceptor drum 1 passing by the cleaner 5 then faces the charger 2 again to be ready for a next imaging operation.

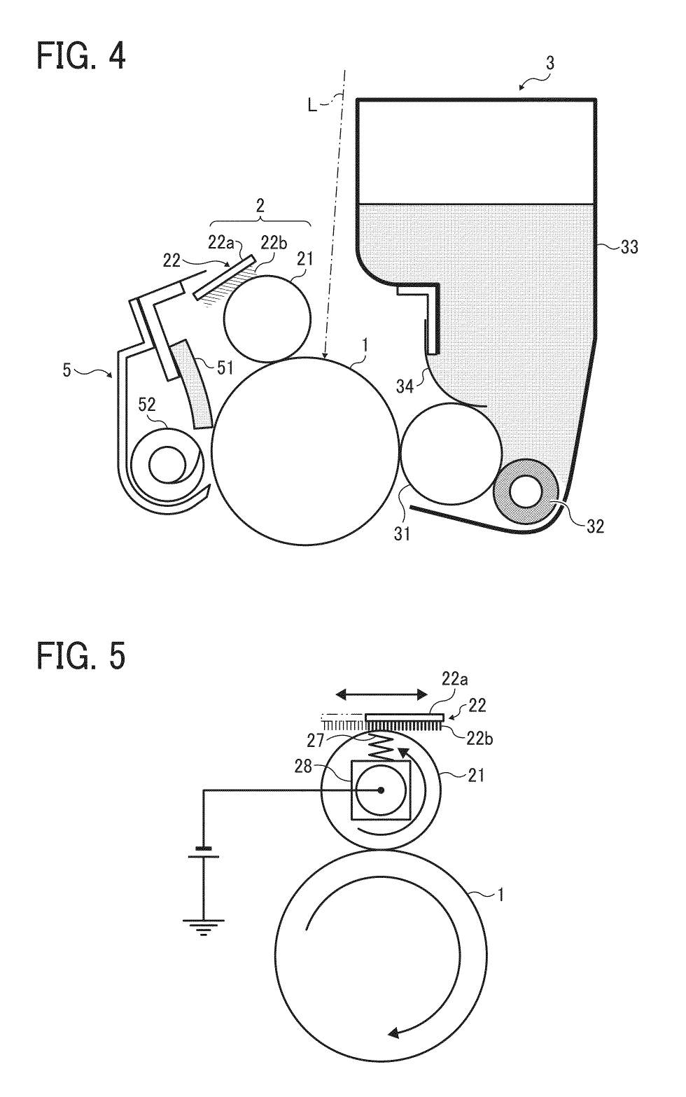

FIG. 4 is a magnified view of the imaging unit in the image forming apparatus illustrated in FIG. 3. The charger 2 includes the charging roller 21 and a charging roller cleaning member 22. The charging roller cleaning member 22 includes a support member 22a and a cleaning member 22b, both of which are platy. The cleaning member 22b is in uniform contact with the charging roller 21 in a longitudinal direction.

According to an embodiment, the cleaning member 22b is comprised of a nylon fiber fur brush or an electrostatic flocking brush, which may be either conductive or non-conductive. When the brush as the cleaning member 22b is brought into contact with a surface of the charging roller 21, toner particles or other substances adhered to the surface of the charging roller 21 are moved by movement of tips of the bristles of the brush and collected within the bristles of the brush. The brush not only effectively cleans the charging roller 21 but also effectively collects toner particles. According to another embodiment, the cleaning member 22b is comprised of a non-woven fabric. When the non-woven fabric as the cleaning member 22b is brought into contact with a surface of the charging roller 21, toner particles or other substances strongly adhered to the surface of the charging roller 21 are effectively rubbed away by the non-woven fabric.

FIG. 5 is a conceptional view of the charging roller cleaning member 22 in accordance with some embodiments. The charging roller cleaning member 22 is capable of reciprocating in a direction tangent to the outer circumference of the charging roller 21, as illustrated in FIG. 5.

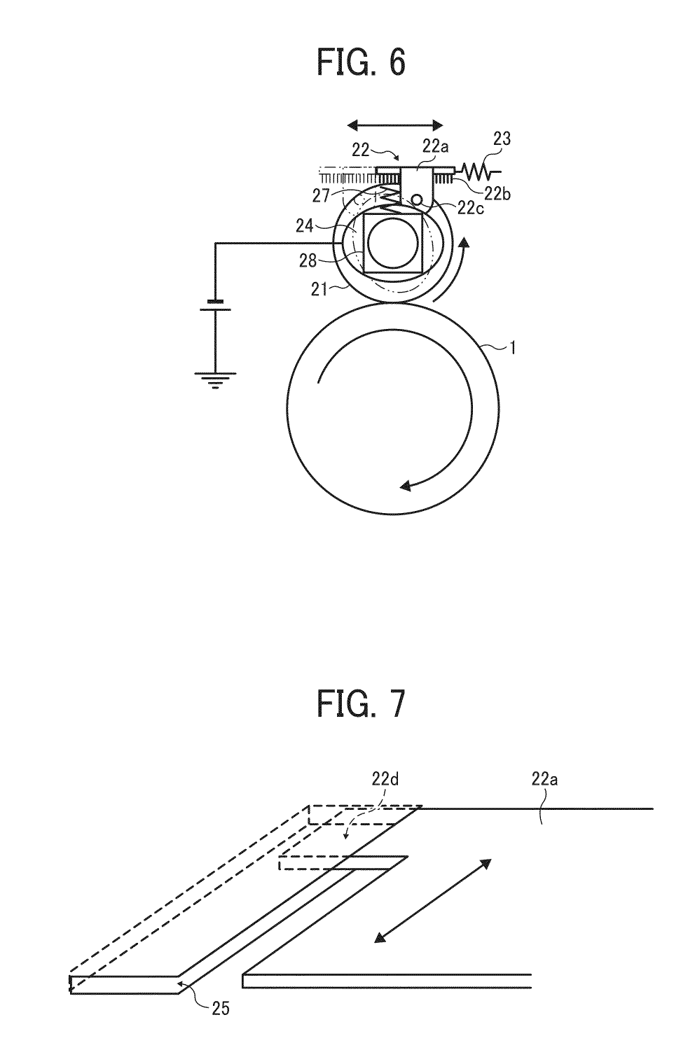

FIG. 6 is an axial cross-sectional view of the charging roller cleaning member 22 according to an embodiment. A roller-shaped cam 24 is disposed on at least one axial end of the charging roller 21. The cam 24 is rotated as the charging roller 21 rotates. The support member 22a has a round shaft 22c that is in continuous contact with an outer circumference of the cam 24. The support member 22a is hooked by one end of a tension spring 23 upstream from the charging roller cleaning member 22 relative to the direction of rotation of the charging roller 21. The other end of the tension spring 23 is fixed to a casing of the charger 2. The tension spring 23 biases the charging roller cleaning member 22 in a certain direction so that the charging roller cleaning member 22 can be brought into reciprocating motion in a direction orthogonal to the longitudinal direction of the charging roller 21. The cam 24 disposed on an axial end of the charging roller 21 rotates in synchronization with rotation of the charging roller 21. The outer circumference of the cam 24 is brought into continuous contact with the charging roller cleaning member 22. With such a configuration, the charging roller 21 is pressed against the photoreceptor drum 1 with a certain pressure. By reciprocating the charging roller cleaning member 22 under such a condition, the charging roller cleaning member 22 is brought into abrasive contact with a whole surface of the charging roller 21 in synchronization with rotation of the charging roller 21.

The motion of the cam 24 may be electrically and timely controlled by the image forming apparatus so that a whole surface of the charging roller cleaning member 22 is brought into abrasive contact with the charging roller 21 at an arbitrary timing.

In place of the tension spring 23, a compression spring may be disposed downstream from the charging roller cleaning member 22 relative to the direction of rotation of the charging roller 21.

FIG. 7 is a perspective view of a guide mechanism for reciprocating the charging roller cleaning member 22. The support member 22a has projections 22d on its both longitudinal ends. When the charging roller cleaning member 22 is mounted on the charger 2, the projections 22d are fit into guide slits 25 that are provided to the casing of the charger 2. The guide slits 25 make the charging roller cleaning member 22 be movable only in a direction tangent to the outer circumference of the charging roller 21 while the charging roller cleaning member 22 is kept in contact with the charging roller 21.

As the charging roller 21 starts rotating, the cam 24 also starts rotating and pressing the round shaft 22c of the charging roller cleaning member 22 in the direction of rotation of the charging roller 21 against a biasing force from the tension spring 23. As a result, the charging roller cleaning member 22 is moved in the direction of rotation of the charging roller 21 while a surface of the charging roller 21 is kept in contact with the cleaning member 22b. The charging roller cleaning member 22 is further moved along the guide slits 25 until the round shaft 22c reaches a position on the outer circumference of the cam 24 where the distance from the rotation center is maximal. The charging roller cleaning member 22 is then moved back in the reverse direction of rotation of the charging roller 21 due to a biasing force from the tension spring 23. Thus, the charging roller cleaning member 22 is brought into reciprocating motion.

The cleaning member 22b is kept in contact with the charging roller 21 while continually changing its contacting surface. This means that the whole surface of the cleaning member 22b is used for cleaning of the charging roller 21.

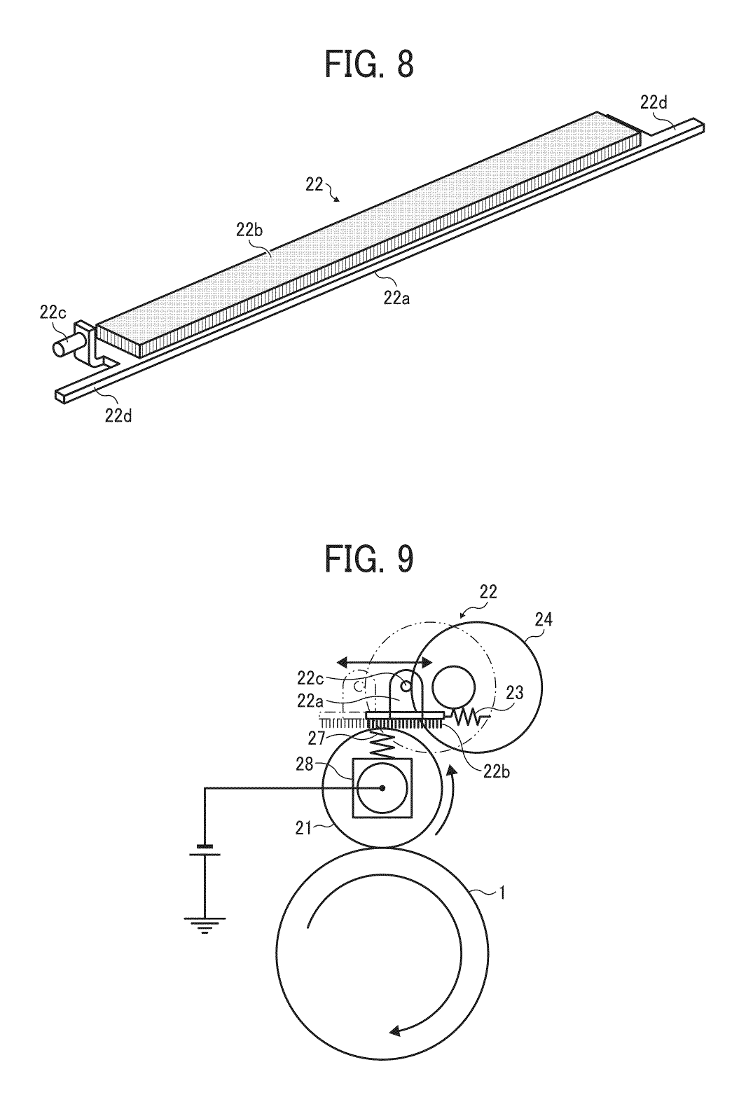

FIG. 8 is a perspective view of the charging roller cleaning member 22 according to an embodiment. As described above, the charging roller cleaning member 22 includes the platy support member 22a, the cleaning member 22b (e.g., a nylon fiber fur brush, an electrostatic flocking brush), the round shaft 22c rotatable in conjunction with rotation of the charging roller 21 while continuously contacting the outer circumference of the cam 24, and the projections 22d that guide reciprocating motion of the charging roller cleaning member 22. The cleaning member 22b may be either conductive or non-conductive. The cleaning member 22b may be comprised of a non-woven fabric in place of the brush.

FIG. 9 is an axial cross-sectional view of the charging roller cleaning member 22 according to another embodiment. In the embodiment illustrated in FIG. 9, the cam 24 is disposed inside or outside the charger 2 and is driven to rotate by a power source.

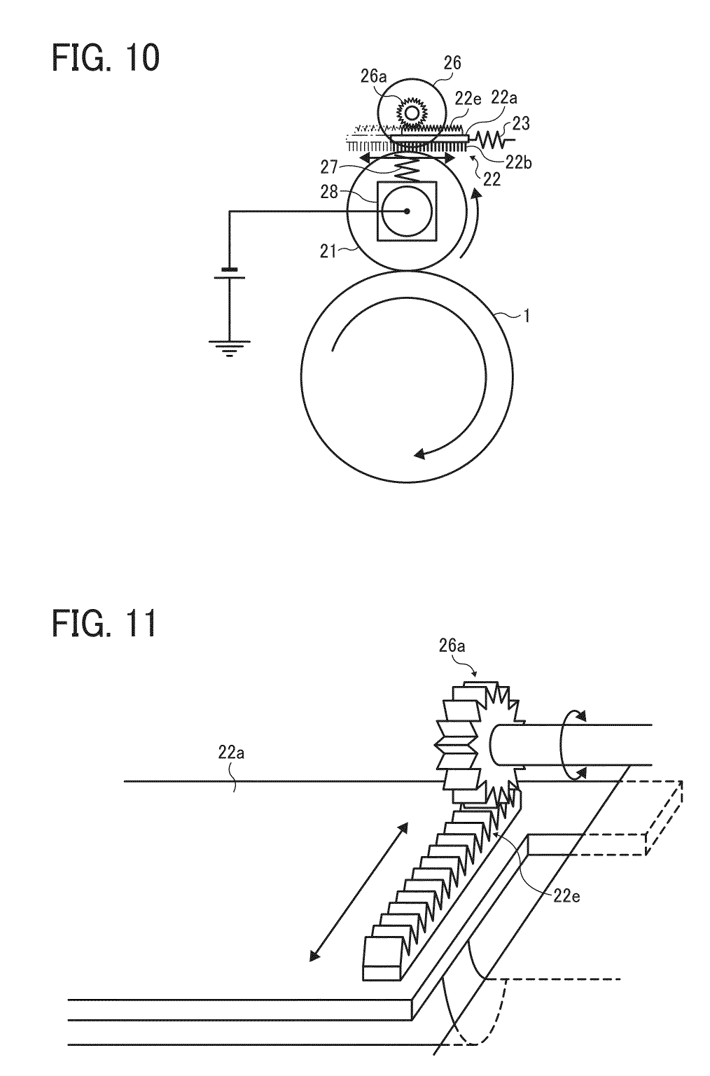

FIG. 10 is an axial cross-sectional view of the charging roller cleaning member 22 according to another embodiment. In the embodiment illustrated in FIG. 10, the charging roller cleaning member 22 is reciprocated by a driving motor 26 fixed to the casing of the charger 2 or image forming apparatus. The charging roller cleaning member 22 has a gear 22e. The teeth of the gear 22e fit into the teeth of a driving gear 26a disposed on the output shaft of the driving motor 26. The driving motor 26 is rotatable in either positive or negative direction depending on the input signal.

As illustrated in FIG. 8, the support member 22a has projections 22d on its both longitudinal ends. When the charging roller cleaning member 22 is mounted on the charger 2, the projections 22d are fit into guide slits 25 that are provided to the casing of the charger 2. The guide slits 25 make the charging roller cleaning member 22 be movable only in a direction tangent to the outer circumference of the charging roller 21 while the charging roller cleaning member 22 is kept in contact with the charging roller 21.

FIG. 11 is a magnified perspective view of the charging roller cleaning member 22 according to an embodiment. The driving motor 26 starts rotating upon reception of a signal input from the image forming apparatus. Rotary motion of the driving gear 26a is converted into linear motion of the gear 22e. Thus, the charging roller cleaning member 22 is linearly moved along the guide slits 25 while contacting a surface of the charging roller 21. The input signal is switched at regular time intervals so that the direction of rotation of the gear 22e is switched reversely. As a result, the direction of linear movement of the charging roller cleaning member 22 is also switched reversely. Thus, the charging roller cleaning member 22 is brought into reciprocating motion.

The gear 22e provided to a part of the charging roller cleaning member 22 makes the charging roller cleaning member 22 be movable in a direction orthogonal to the longitudinal direction of the charging roller 21 while the charging roller cleaning member 22 is in continuous contact with the charging roller 21. The driving gear 26a that fits into the gear 22e and a driving source that drives the driving gear 26a are provided adjacent to the charging roller 21. The driving source is electrically controlled by the image forming apparatus. The above configuration makes it possible to continuously reciprocate the charging roller cleaning member 22 in a direction orthogonal to the longitudinal direction of the charging roller 21.

By controlling the input signal, the charging roller cleaning member 22 may be reciprocated in either a continuous or stepwise manner while the photoreceptor drum 1 is rotating. By continually changing a contact surface of the cleaning member 22b with the charging roller 21, the whole surface of the cleaning member 22b can be used for cleaning of the charging roller 21.

Additional modifications and variations in accordance with further embodiments of the present invention are possible in light of the above teachings. It is therefore to be understood that within the scope of the appended claims the invention may be practiced other than as specifically described herein.

What is claimed is:

1. A charger adapted to uniformly charge a surface of an image bearing member, the charger including:
a charging roller being in contact with a surface of the image bearing member, the charging roller being rotatable;
a charging roller cleaning member being in uniform contact with the charging roller in a longitudinal direction; and
a cleaning member moving device adapted to reciprocate the charging roller cleaning member in a direction orthogonal to the longitudinal direction of the charging roller while keeping the charging roller cleaning member in contact with the charging roller.

2. The charger according to claim 1,
wherein the charging roller cleaning member includes:
a cleaning member being in contact with a surface of the charging roller;
a support member supporting the cleaning member; and
a biasing member adapted to bias the charging roller cleaning member in a direction orthogonal to the longitudinal direction of the charging roller while keeping the charging roller cleaning member in contact with the charging roller,
wherein the cleaning member moving device includes:
a cam being disposed on at least one end of the charging roller, the cam being integrally rotatable with the charging roller and in continuous contact with the charging roller cleaning member, and
wherein the charging roller cleaning member is moved in an opposite direction to the direction of biasing of the biasing member when the charging roller rotates.

3. The charger according to claim 2, wherein the cleaning member has a plate-like shape.

4. The charger according to claim 2, wherein the cleaning member has a brush-like shape.

5. The charger according to claim 2, wherein the cleaning member includes a non-woven fabric.

6. The charger according to claim 2, wherein the cleaning member includes an elastic foamed material.

7. The charger according to claim 1,
wherein the charging roller cleaning member includes:
a cleaning member being in contact with a surface of the charging roller,
a support member supporting the cleaning member; and
a biasing member adapted to bias the charging roller cleaning member in a direction orthogonal to the longitudinal direction of the charging roller while keeping the charging roller cleaning member in contact with the charging roller,
wherein the cleaning member moving device includes:
a driving motor having an output shaft; and
a cam being disposed on at least one end of the output shaft, the cam being integrally rotatable with the output shaft while being in continuous contact with the charging roller cleaning member, and
wherein the charging roller cleaning member is moved in an opposite direction to the direction of biasing of the biasing member when the output shaft rotates.

8. The charger according to claim 7, wherein the cleaning member has a plate-like shape.

9. The charger according to claim 7, wherein the cleaning member has a brush-like shape.

10. The charger according to claim 7, wherein the cleaning member includes a non-woven fabric.

11. The charger according to claim 7, wherein the cleaning member includes an elastic foamed material.

12. The charger according to claim 1,
wherein the charging roller cleaning member includes:
a cleaning member being in contact with a surface of the charging roller;
a support member supporting the cleaning member; and
a gear,
wherein the cleaning member moving device includes:
a driving motor having an output shaft; and
a driving gear being disposed on at least one end of the output shaft, the driving gear being integrally rotatable with the output shaft in either a positive or negative direction while fitting into the gear, and
wherein the charging roller cleaning member is moved in a direction orthogonal to the longitudinal direction of the charging roller while keeping in contact with the charging roller when the output shaft rotates.

13. The charger according to claim 12, wherein the cleaning member has a plate-like shape.

14. The charger according to claim 12, wherein the cleaning member has a brush-like shape.

15. The charger according to claim 12, wherein the cleaning member includes a non-woven fabric.

16. The charger according to claim 12, wherein the cleaning member includes an elastic foamed material.

17. An image forming apparatus, comprising:
an image bearing member;
a charger adapted to uniformly charge a surface of the image bearing member, the charger including:
a charging roller being in contact with a surface of the image bearing member, the charging roller being rotatable;
a charging roller cleaning member being in uniform contact with the charging roller in a longitudinal direction; and
a cleaning member moving device adapted to reciprocate the charging roller cleaning member in a direction orthogonal to the longitudinal direction of the charging roller while keeping the charging roller cleaning member in contact with the charging roller;
an irradiator adapted to irradiate the charged surface of the image bearing member to form an electrostatic latent image thereon;
a developing device adapted to develop the electrostatic latent image into a toner image with toner particles;
a transfer device adapted to transfer the toner image from the image bearing member onto a recording medium or an intermediate transfer medium; and
a cleaner adapted to remove residual toner particles remaining on the image bearing member without being transferred.

18. The image forming apparatus according to claim 17,
wherein the charging roller cleaning member includes:
a cleaning member being in contact with a surface of the charging roller;
a support member supporting the cleaning member; and
a biasing member adapted to bias the charging roller cleaning member in a direction orthogonal to the longitudinal direction of the charging roller while keeping the charging roller cleaning member in contact with the charging roller,
wherein the cleaning member moving device includes:
a cam being disposed on at least one end of the charging roller, the cam being integrally rotatable with the charging roller and in continuous contact with the charging roller cleaning member, and
wherein the charging roller cleaning member is moved in an opposite direction to the direction of biasing of the biasing member when the charging roller rotates.

19. The image forming apparatus according to claim 17,
wherein the charging roller cleaning member includes:
a cleaning member being in contact with a surface of the charging roller,;
a support member supporting the cleaning member; and
a biasing member adapted to bias the charging roller cleaning member in a direction orthogonal to the longitudinal direction of the charging roller while keeping the charging roller cleaning member in contact with the charging roller,
wherein the cleaning member moving device includes:
a driving motor having an output shaft; and
a cam being disposed on at least one end of the output shaft, the cam being integrally rotatable with the output shaft while being in continuous contact with the charging roller cleaning member, and
wherein the charging roller cleaning member is moved in an opposite direction to the direction of biasing of the biasing member when the output shaft rotates.

20. The image forming apparatus according to claim 17,
wherein the charging roller cleaning member includes:
a cleaning member being in contact with a surface of the charging roller;
a support member supporting the cleaning member; and
a gear,
wherein the cleaning member moving device includes:
a driving motor having an output shaft; and
a driving gear being disposed on at least one end of the output shaft, the driving gear being integrally rotatable with the output shaft in either a positive or negative direction while fitting into the gear, and
wherein the charging roller cleaning member is moved in a direction orthogonal to the longitudinal direction of the charging roller while keeping in contact with the charging roller when the output shaft rotates.
